(19) United States
(12) Patent Application Publication
(10) Pub. No.: US 2024/0070894 A1
(43) Pub. Date: Feb. 29, 2024

(54) OBJECT DETECTION DEVICE AND METHOD

(71) Applicant: Panasonic Intellectual Property Management Co., Ltd., Osaka (JP)

(72) Inventors: Akihiro TANAKA, Osaka (JP); Daijiroh ICHIMURA, Hyogo (JP)

(21) Appl. No.: 18/383,518

(22) Filed: Oct. 25, 2023

Related U.S. Application Data
(63) Continuation of application No. PCT/JP2021/048247, filed on Dec. 24, 2021.

(30) Foreign Application Priority Data
May 13, 2021 (JP) 2021-081787

(51) Int. Cl. G06T 7/70; G06T 7/20

(52) U.S. Cl. CPC G06T 7/70; G06T 7/20

(57) ABSTRACT

An object detection device for detecting a position of an object on an imaging plane imaged by a camera, including: a processor to acquire image data generated by the camera and perform coordinate transformation, with respect to a position of the object, from first coordinates associated with an image indicated by the image data to second coordinates associated with the imaging plane; and a memory to store setting information used for the coordinate transformation, wherein the setting information includes a set value indicating a height from the imaging plane for each type among a plurality of types of objects, and the processor acquires a position of the object in the first coordinates and a type of the object based on the image data and calculates a position of the object in the second coordinates by performing the coordinate transformation using the set value corresponding to the type of the object.

### TECHNICAL FIELD

The present disclosure relates to an object detection device and method.

### BACKGROUND ART

JP 2019-114280 A discloses an object tracking system including a plurality of detection units that detect an object from videos captured by a plurality of cameras, and an integrated tracking unit that associates current and past positions of the object based on detecting results of the detection units. The detecting result of each detection unit includes the coordinate value of the lower end of the object (such as a point at which the object contacts the ground) in the coordinate system on the captured image of the corresponding camera and information indicating a circumscribed rectangle of the object. Each detection unit converts a coordinate value on a captured image into a coordinate value in a common coordinate system defined in a photographing space by the plurality of cameras using camera parameters indicating the position, the attitude, and the like of each camera obtained in advance by calibration. The integrated tracking unit tracks the object by integrating the coordinate values in the common coordinate system which are obtained from the plurality of detection units.

### SUMMARY

### Problems to be Solved by the Invention

The present disclosure provides an object detection device and method which can accurately detect the positions of various objects on an imaging plane imaged by a camera.

### Solutions to the Problems

An object detection device according to one aspect of the present disclosure detects the position of an object on an imaging plane imaged by a camera. The object detection device includes a processor and a memory. The processor acquires the image data generated by image capturing by the camera. The controller performs the coordinate transformation, with respect to the position of the object, from first coordinates associated with the image indicated by the image data to second coordinates associated with the imaging plane. The memory stores setting information used for the coordinate transformation. The setting information includes a set value indicating a height from the imaging plane for each type of object among a plurality of types of objects. The processor acquires a position of the object in the first coordinates and a type of the object based on the image data. The processor calculates a position of the object in the second coordinates by performing the coordinate transformation using the set value corresponding to the type of the object.

An object detection device according to another aspect of the present disclosure detects a position of an object on an imaging plane imaged by a camera. The object detection device includes a processor, a memory, and an interface. The processor acquires the image data generated by image capturing by the camera. The controller performs coordinate transformation, with respect to a position of the object, from first coordinates associated with the image indicated by the image data to second coordinates associated with the imaging plane. The memory stores setting information used for the coordinate transformation. The interface acquires information in accordance with a user operation. The setting information includes a set value indicating a height from the imaging plane for each type of object among a plurality of types of objects. The interface acquires a set value for each of the plurality of types in accordance with a user operation inputting a set value. The processor acquires, based on the acquired image data, a detection result in which a position of the object in the first coordinates is associated with a type of the object discriminated from the plurality of types. The processor performs, for each type of object in the detection result, the coordinate transformation in accordance with the set value acquired by the user operation to calculate a position of the object in the second coordinates.

These general and specific aspects may be implemented by systems, methods, and computer programs, and combinations thereof.

### Effects of the Invention

According to the object detection device, method, and system according to the present disclosure, it is possible to accurately detect the positions of various objects on the imaging plane imaged by the camera.

### BRIEF DESCRIPTION OF DRAWINGS

FIG. 1 is a diagram for explaining an object detection system according to a first embodiment;

FIG. 2 is a block diagram exemplarily illustrating the configuration of a terminal device according to the first embodiment;

FIG. 3 is a block diagram exemplarily illustrating the configuration of a trajectory extraction server according to the first embodiment;

FIG. 4 is a diagram for explaining trajectory information in the object detection system;

FIGS. 5A to 5C are diagrams for explaining a problem regarding the object detection system;

FIG. 6 is a flowchart exemplarily illustrating the basic operation of the trajectory extraction server in the object detection system;

FIG. 7 is a flowchart exemplarily illustrating position calculation processing in the trajectory extraction server of the object detection system according to the first embodiment;

FIGS. 8A and 8B are diagrams for explaining position calculation processing;

FIG. 9 is a diagram exemplarily illustrating the data structure of object feature information in the object detection system according to the first embodiment;

FIGS. 10A and 10B are diagrams for explaining an effect regarding the trajectory extraction server;

FIG. 11 is a flowchart exemplarily illustrating setting processing in the terminal device according to the first embodiment;

FIG. 12 is a diagram illustrating a display example of a setting screen in the terminal device according to the first embodiment;

FIG. 13 is a flowchart exemplarily illustrating learning processing of the object detection model in the trajectory extraction server according to the first embodiment;

FIG. 14 is a flowchart exemplarily illustrating position calculation processing in the object detection system according to a second embodiment;

FIG. 15 is a diagram for explaining position calculation processing in the object detection system according to the second embodiment;

FIG. 16 is a flowchart exemplarily illustrating position calculation processing in an object detection system according to a third embodiment; and

FIGS. 17A to 17C are diagrams for explaining position calculation processing in the object detection system according to the third embodiment.

### DETAILED DESCRIPTION

Embodiments will be described in detail below with reference to the accompanying drawings as appropriate. However, detailed descriptions more than necessary may be omitted. For example, detailed description of an already well-known matter and a duplicate description of substantially the same configuration may be omitted. This is to avoid unnecessary redundancy of the following description and to facilitate the understanding of those skilled in the art.

It should be noted that the applicant provides the accompanying drawings and the following description in order to allow those skilled in the art to fully understand the present disclosure and does not intend to make them limit the subject matter described in the claims.

1. Configuration

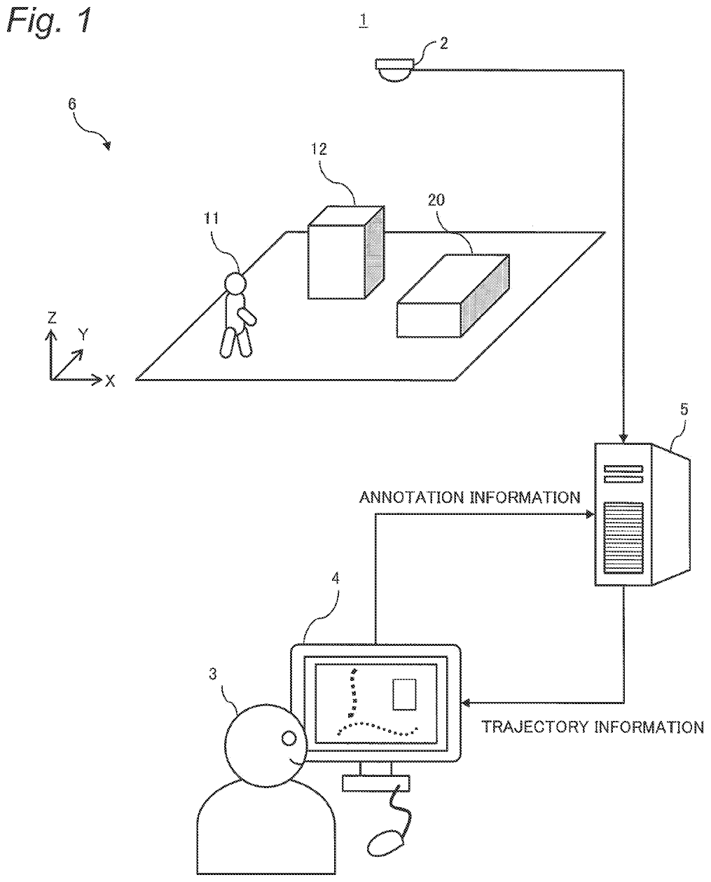

An object detection system according to the first embodiment will be described with reference to FIG. 1. FIG. 1 is a diagram illustrating an outline of an object detection system 1 according to the present embodiment.

1-1. System Overview

As illustrated in FIG. 1, the object detection system 1 according to the present embodiment includes an omnidirectional camera 2, a terminal device 4, and a trajectory extraction server 5, for example. The trajectory extraction server 5 is an example of an object detection device according to the present embodiment. For example, the system 1 is applicable to an application of detecting the positions of a person 11, a target object 12 such as cargo, and the like in a workplace 6 such as a factory, and analyzing a trajectory based on the detected positions. The terminal device 4 of the system 1 is used by the user 3, such as an administrator or a person in charge of data analysis in the workplace 6, to analyze a trajectory and preliminary perform annotation work for setting information regarding a detection target, for example.

Hereinafter, the vertical direction in the workplace 6 is referred to as a Z direction. Two directions perpendicular to each other on a horizontal plane orthogonal to the Z direction are referred to as an X direction and a Y direction, respectively. Further, the +Z direction may be referred to as an above direction, and the −Z direction may be referred to as a downward direction. Further, a horizontal plane with Z=0 may be referred to as a horizontal plane in the workplace 6. The horizontal plane in the workplace 6 is an example of an imaging plane imaged by the omnidirectional camera 2 in the present embodiment.

FIG. 1 illustrates an example in which various equipment 20 and the like are installed in the workplace 6 separately from targets for detection such as the person 11 and the target object 12. In the example of FIG. 1, the omnidirectional camera 2 is arranged on the ceiling or the like of the workplace 6 to overlook the workplace 6 from above. In the system 1, the trajectory extraction server 5 associates results of detecting positions of the person 11, the target object 12, and the like in an image captured by the omnidirectional camera 2 with positions according to the horizontal plane in the workplace 6 so that the trajectory can be displayed on the map of the workplace 6 by the terminal device 4, for example.

In the present embodiment, in the object detection system 1 as stated above, an object detection device and method which can accurately detect the positions of various objects such as the person 11 and the target object 12 in the workplace 6 are provided. Hereinafter, the configuration of each unit in the system 1 will be described.

The omnidirectional camera 2 is an example of a camera in the system 1. For example, the omnidirectional camera 2 includes an optical system such as a fisheye lens and an imaging element such as a CCD or CMOS image sensor. For example, the omnidirectional camera 2 performs an imaging operation according to a stereographic projection method to generate image data indicating a captured image. The omnidirectional camera 2 is connected to the trajectory extraction server 5 so that image data is transmitted to the trajectory extraction server 5, for example.

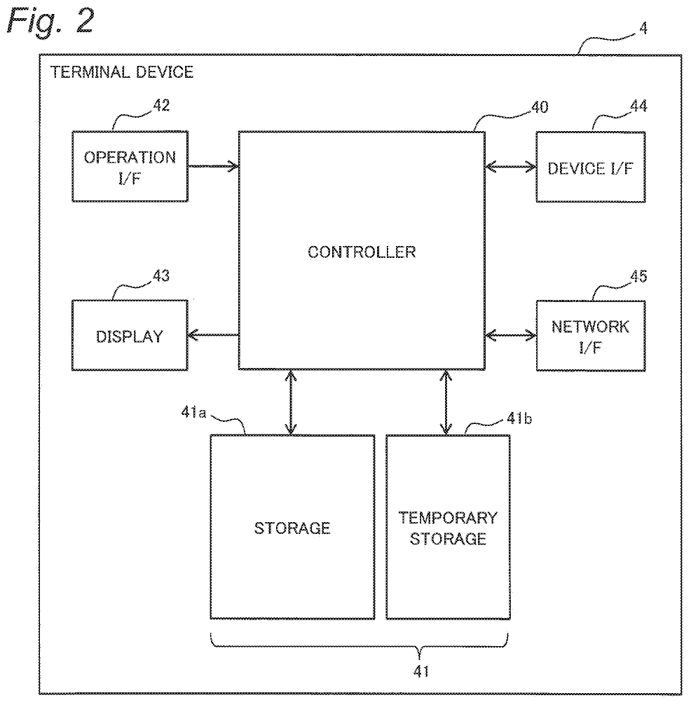

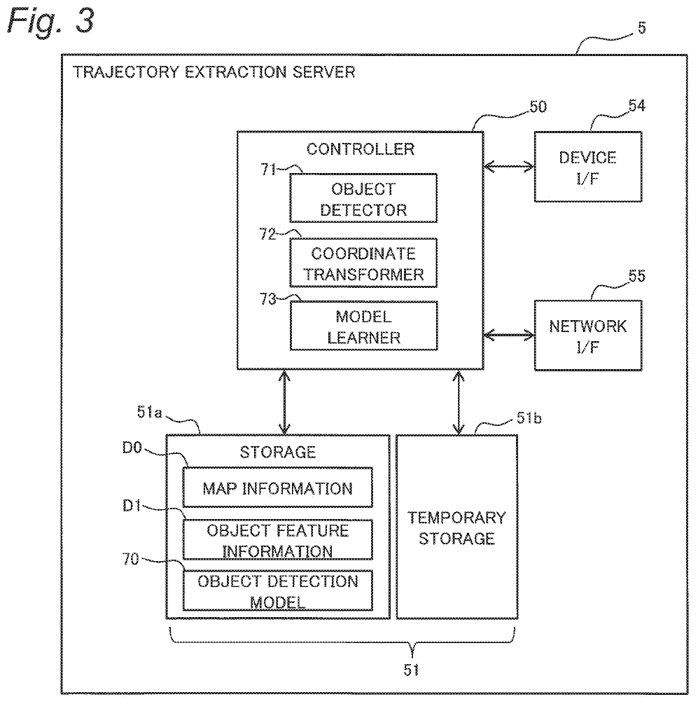

The trajectory extraction server 5 is implemented with an information processing device such as a computer. The terminal device 4 is implemented with an information processing device such as a personal computer (PC). The terminal device 4 is connected to the trajectory extraction server 5 communicably with the trajectory extraction server 5 via a communication network such as the Internet. The configurations of the trajectory extraction server 5 and the terminal device 4 will be described with reference to FIGS. 2 and 3, respectively.

1-2. Configuration of Terminal Device

FIG. 2 is a block diagram exemplarily illustrating the configuration of the terminal device 4. The terminal device 4 exemplarily illustrated in FIG. 2 includes a controller 40, a memory 41, an operation interface 42, a display 43, a device interface 44, and a network interface 45. The interface will be abbreviated as “I/F” below.

The controller 40 includes a CPU or MPU that implements a predetermined function in cooperation with software for example. The controller 40 controls the overall operation of the terminal device 4, for example. The controller 40 performs, reading out data and programs stored in the memory 41, a variety of arithmetic processing to implement various functions. The above program may be provided via a communication network such as Internet or may be stored in a portable recording medium. A controller 50 may include various semiconductor integrated circuits such as a GPU.

The memory 41 is a storage medium that stores programs and data necessary for implementing the functions of the terminal device 4. As illustrated in FIG. 2, the memory 41 includes a storage 41a and a temporary storage 41b.

The storage 41a stores parameters, data, a control program, and the like for implementing a predetermined function. The storage 41a is implemented with an HDD or SSD, for example. For example, the storage 41a stores the above-described program and the like. The storage 41a may store image data indicating a map of the workplace 6.

The operation interface 42 is a general term for operation members operated by the user. The operation interface 42 may form a touch panel together with the display 43. The operation interface 42 is not limited to the touch panel and may be a keyboard, a touch pad, buttons, or switches, for example. The operation interface 42 is an example of an information input interface that acquires information in accordance with a user operation.

The display 43 is an example of an output interface configured by a liquid crystal display or organic EL display, for example. The display 43 may display various types of information such as various icons for operating the operation interface 42 and information input from the operation interface 42.

The device I/F 44 is a circuit for connecting an external device such as the omnidirectional camera 2 to the terminal device 4. The device I/F 44 performs communication in accordance with predetermined communication standards. The predetermined standards include USB, HDMI (registered trademark), IEEE1395, Wi-Fi (registered trademark), and Bluetooth (registered trademark). In the terminal device 4, the device I/F 44 may serve as an acquisition interface that receives various types of information from an external device or an output interface that transmits various types of information to the external device.

The network I/F 45 is a circuit for connecting the terminal device 4 to a communication network via a wireless or wired communication line. The network I/F 45 performs communication in accordance with predetermined communication standards. The predetermined communication standards include communication standards such as IEEE802.3 and IEEE802.11a/11b/11g/11ac. The network I/F 45 may configure an acquisition interface for receiving various information or an output interface for transmitting various information in the terminal device 4 via the communication network. For example, the network I/F 45 may be connected to the omnidirectional camera 2 and the trajectory extraction server 5 via a communication network.

1-3. Configuration of Trajectory Extraction Server

FIG. 3 is a block diagram exemplarily illustrating the configuration of the trajectory extraction server 5. Trajectory extraction server 5 illustrated in FIG. 3 includes the controller 50, a memory 51, a device I/F 54, and a network I/F 55.

The controller 50 includes, for example, a CPU or MPU that implements a predetermined function in cooperation with software. For example, the controller 50 controls the overall operation of the trajectory extraction server 5. The controller 50 performs, reading out data and programs stored in the memory 51, a variety of arithmetic processing to implement various functions. For example, the controller 50 includes an object detector 71, a coordinate transformer 72, and a model learner 73 as functional configurations.

By applying various image recognition techniques to image data, the object detector 71 detects a position of an object of a processing target set in advance and recognizes a region where the object of the processing target appears in an image indicated by the image data. The detection result obtained by the object detector 71 may include information indicating the time when an image captured where the region of the processing target is recognized, for example. The object detector 71 is implemented by the controller 50 reading out and executing the object detection model 70 stored in advance in the memory 51 or the like, for example. The coordinate transformer 72 performs coordinate transformation between predetermined coordinate systems with respect to the position of the region recognized in the image. The model learner 73 executes machine learning to generate the object detection model 70. The operation of the trajectory extraction server 5 based on each type of function will be described later.

The controller 50 executes a program including a command group for implementing the function of the trajectory extraction server 5 described above, for example. The above program may be provided via a communication network such as Internet or may be stored in a portable recording medium. Further, the controller 50 may be a hardware circuit such as a dedicated electronic circuit or a reconfigurable electronic circuit designed to implement each of the above functions. The controller 50 may be implemented with various semiconductor integrated circuits such as CPU, MPU, GPU, GPGPU, TPU, microcomputer, DSP, FPGA, and ASIC.

The memory 51 is a storage medium that stores a program and data necessary for implementing the function of the trajectory extraction server 5. As illustrated in FIG. 3, the memory 51 includes a storage 51a and a temporary storage 51b.

The storage 51a stores parameters, data, a control program, and the like for implementing a predetermined function. The storage 51a is implemented with an HDD or SSD, for example. For example, the storage 51a stores the above program, map information DO, object feature information D1, object detection model 70, and the like.

The map information DO indicates the arrangement of the various equipment 20 in the workplace 6 in a predetermined coordinate system, for example. The object feature information D1 indicates a feature of the height of the object set for each type of object with respect to the object of the processing target of the object detector 71. The details of the object feature information D1 will be described later. The object detection model 70 is a learned model implemented with a neural network such as a convolutional neural network. The object detection model 70 includes various parameters such as a weight parameter indicating a learning result, for example.

The temporary memory 51b is configured by a RAM such as DRAM or SRAM and temporarily stores (i.e., holds) data, for example. For example, the temporary memory 51b holds image data and the like received from the omnidirectional camera 2. Further, the temporary memory 51b may function as a working area of the controller 50 or may be implemented as a storage area in the internal memory of the controller 50.

The device I/F 54 is a circuit for connecting an external device such as the omnidirectional camera 2 to the trajectory extraction server 5. The device I/F 54 performs communication in accordance with a predetermined communication standard similarly to the device I/F 44 of the terminal device 4, for example. The device I/F 54 is an example of an acquisition interface that receives image data and the like from the omnidirectional camera 2. The device I/F 54 may serve as an output interface that transmits various types of information to an external device in the trajectory extraction server 5.

Network I/F 55 is a circuit for connecting the trajectory extraction server 5 to a communication network via a wireless or wired communication line. For example, similarly to the network I/F 45 of the terminal device 4, the network I/F 55 performs communication in accordance with a predetermined communication standard. The network I/F 55 may configure an acquisition interface for receiving various information or an output interface for transmitting various information in the trajectory extraction server 5 via the communication network. For example, the network I/F 55 may be connected to the omnidirectional camera 2 and the terminal device 4 via a communication network.

The configurations of the terminal device 4 and the trajectory extraction server 5 as described above are merely examples, and the configurations are not limited to the above examples. The object detection method according to the present embodiment may be executed in distributed computing. The acquisition interfaces in the terminal device 4 and the trajectory extraction server 5 may be implemented respectively by the controllers 40 and 50 and the like in cooperation with various kinds of software. The acquisition interface may acquire various pieces of information by reading various pieces of information stored in various storage media (e.g., the storages 41a and 51a) to working areas (e.g., temporary storages 41b and 51b) of the controllers 40 and 50.

The object detection model 70 may be stored in an external information processing device communicably connected to the trajectory extraction server 5. In the trajectory extraction server 5, the device I/F 54 and/or the network I/F 55 may serve as an information input interface that acquires information in accordance with a user operation.

2. Operation

Operations of the object detection system 1, the trajectory extraction server 5, and the terminal device 4 configured as described above will be described below.

In the system 1, for example, as illustrated in FIG. 1, the omnidirectional camera 2 performs image capturing of moving image of the workplace 6, in which the person 11, the target object 12, and the like are moving, to generate image data indicating a captured image for each frame cycle of the moving image, and transmits the image data to the trajectory extraction server 5.

Upon receiving the image data from the omnidirectional camera 2, the trajectory extraction server 5 inputs the received image data to the object detection model 70 to detect the positions of the person 11, the target object 12, and the like, for example. With respect to the positions of the person 11, the target object 12, and the like, the trajectory extraction server 5 repeats coordinate transformation from coordinates associated with the image indicated by the image data to coordinates associated with the horizontal plane of the workplace 6 and generates trajectory information. The trajectory information is information in which the trajectories of the person 11, the target object 12, and the like are associated with the map information DO, for example. The trajectory extraction server 5 transmits the generated trajectory information to the terminal device 4, for example.

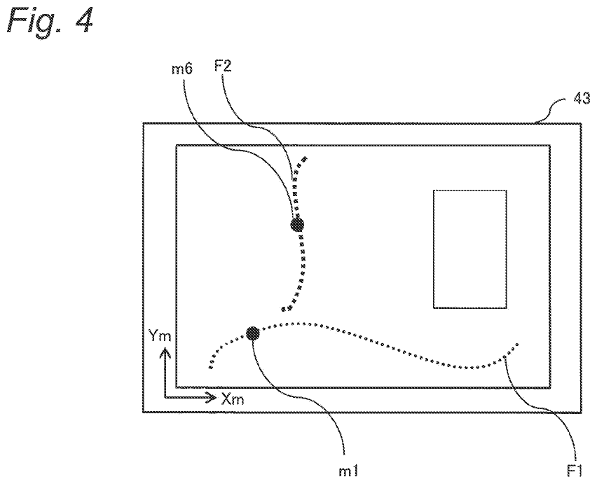

The terminal device 4 displays the received trajectory information on the display 43, for example. FIG. 4 illustrates a display example of the trajectory information generated by the trajectory extraction server 5 based on the captured image of the workplace 6 in FIG. 1. In the example of FIG. 4, a trajectory F1 of the person 11 and a trajectory F2 of the target object 12 are displayed on the display 43 of the terminal device 4. The trajectories F1 and F2 indicate the loci of map positions m1 and m6 of the person 11 and the target object 12 in the map coordinate system, respectively, calculated by the trajectory extraction server 5.

The map coordinate system is an example of a coordinate system associated with the imaging plane by the omnidirectional camera 2 and indicates the position in the workplace 6 based on the map information DO, for example. The map coordinate system includes an Xm coordinate for indicating a position in the workplace 6 in the X direction and a Ym coordinate for indicating a position in the workplace 6 in the Y direction, for example. The map position indicates the position of the object in the map coordinate system.

2-1. Problem Regarding Object Detection System

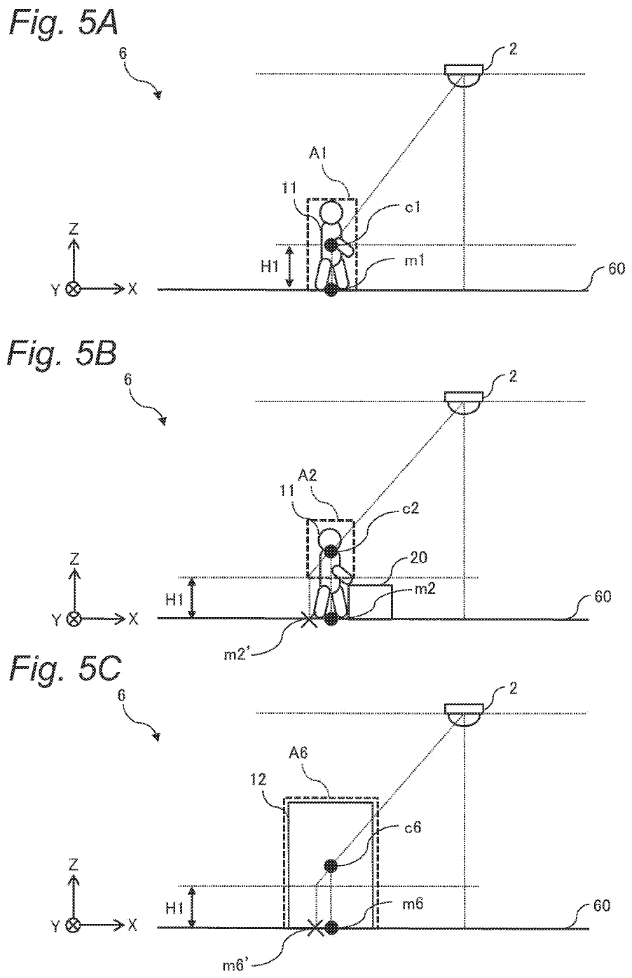

A situation that poses a problem when extracting the trajectories F1 and F2 as described above will be described with reference to FIGS. 5A to 5C.

FIGS. 5A to 5C are diagrams for explaining a problem regarding the object detection system 1. FIGS. 5A to 5C illustrate states in which the omnidirectional camera 2, the person 11, and the target object 12 in the workplace 6 are viewed from the Y direction.

FIG. 5A illustrates a situation in which the whole body of the person 11 appears in an image captured by the omnidirectional camera 2. FIG. 5B illustrates a situation in which only a part of the person 11 appears in the captured image. FIG. 5C illustrates a situation in which the target object 12 different from the person 11 appears in the captured image.

In the example of FIG. 5A, the object detection model 70 of the trajectory extraction server 5 recognizes a detection region A1 of the whole body of the person 11 in a captured image from the omnidirectional camera 2. The detection region A1 indicates a detection result of a position of the whole body by the object detection model 70. In this example, the trajectory extraction server 5 calculates the map position m1 from a detected position indicating the center of detection region A1 on the captured image. For example, the map position m1 is calculated as a position of a point where a line perpendicular drawn from a target position c1 in the workplace 6 to the horizontal plane 60 of the workplace 6 intersects with the horizontal plane 60, the target position corresponding to the detected position of the detection region A1. The target position indicates a position in the space of the workplace 6 corresponding to the detected position on the captured image.

The trajectory extraction server 5 of the present embodiment performs position calculation as described above using a reference height that is a parameter regarding a height of the object, the reference height being set in advance in the object feature information D1. In the example of FIG. 5A, the map position m1 corresponding to the target position c1 can be accurately calculated by using a reference height H1.

On the other hand, in the example of FIG. 5B, the object detection model 70 recognizes a detection region A2 of the upper body of the person 11. In the example of FIG. 5B, a part of the body of the person 11 is hidden behind the equipment 20 in the workplace 6 and is not shown in the captured image in the direction from the omnidirectional camera 2 toward the person 11. As a result, in the example of FIG. 5B, a target position c2 for the detection region A2 of the upper body is above the target position c1 for the detection region A1 of the whole body in FIG. 5A. In this case, when the position calculation of the detection region A2 is performed similarly to the case of FIG. 5A, a calculated position m2′ shifts from the map position m2 corresponding to the target position c2.

In the example of FIG. 5C, the object detection model 70 recognizes a detection region A6 of the target object 12. Here, since the heights of the target object 12 and the person 11 are different, a target position c6 for the detection region A6 is above the target position c1 in the example of FIG. 5A. Therefore, in this case as well, when the position calculation of the detection region A6 is performed in the same manner as described above, the calculated position m6′ shifts from the map position m6 corresponding to the target position c6 as illustrated in FIG. 5C.

As described above, when the same reference height H1 is used in position calculation regardless of the types of detection regions A1 to A6 in captured images, a possible problem is that the calculated positions shift from the map positions m1 to m6 for the detection regions A1 to A6.

Therefore, in trajectory extraction server 5 according to the present embodiment, by setting in advance, in the object feature information D1, a reference height according to a type of the processing target of object detector 71, coordinate transformation is performed using the reference height according to the type in position calculation. Accordingly, even when a detection region of a part of the body of the person 11 is recognized as illustrated in FIG. 5B or a detection region of the target object 12 having a height different from that of the person 11 in FIG. 5A is recognized as illustrated in FIG. 5C, the map positions m2 and m6 can be accurately calculated, for example.

In addition, in the system 1, the terminal device 4 receives a user operation for performing various kinds of pre-setting regarding the operation of the trajectory extraction server 5 as described above. For example, before learning the object detection model 70, the terminal device 4 according to the present embodiment acquires various types of setting information such as annotation information input in annotation work by the user 3 or the like and transmits the acquired setting information to the trajectory extraction server 5. The operation of the trajectory extraction server 5 based on such setting information will be described below.

2-2. Basic Operation

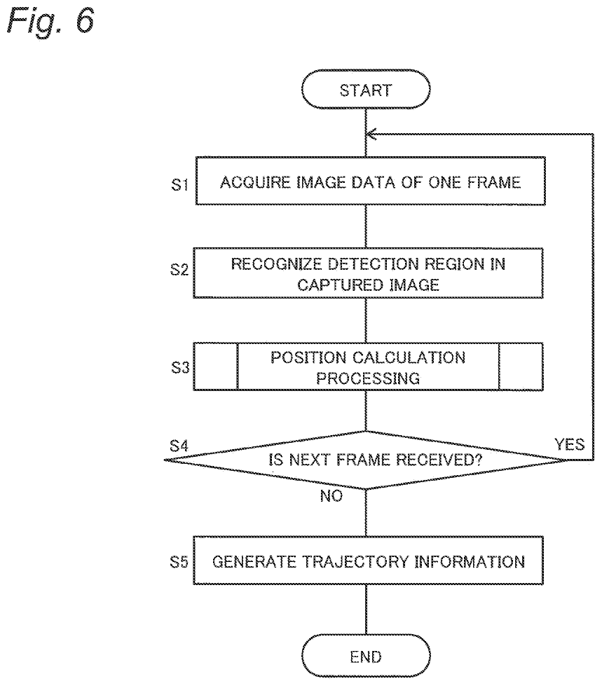

Hereinafter, the basic operation of the trajectory extraction server 5 in the system 1 will be described with reference to FIG. 6.

FIG. 6 is a flowchart illustrating the basic operation of the trajectory extraction server 5 in object detection system 1. For example, the controller 50 of the trajectory extraction server 5, functioning as the object detector 71 and the coordinate transformer 72, performs each processing illustrated in the flowchart of FIG. 6.

First, the controller 50 acquires image data of one frame from the device I/F 54 (S1), for example. The device I/F 54 sequentially receives image data of each frame from the omnidirectional camera 2.

Next, the controller 50 functioning as the object detector 71 performs image recognition processing for object detection on the image indicated by the acquired image data. The controller 50 thereby recognizes detection regions of the person 11 and the target 12 (S2). The controller 50 acquires a detection result and then holds the detection result in the temporary storage 51b, for example.

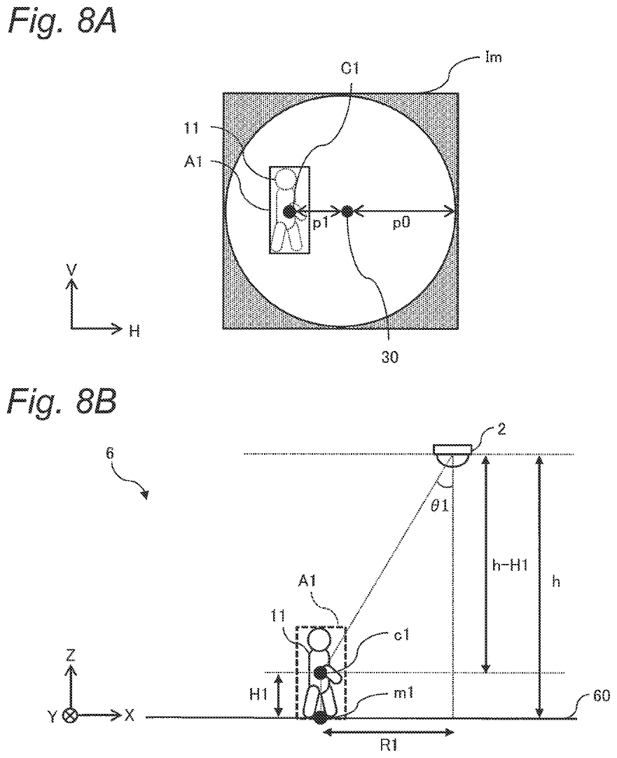

In step S2, the object detector 71 outputs, as the detection result, a detection region associating with any of a plurality of preset classes, the detection region indicating a region where a processing target classified into any of the classes appears in an image, for example. The plurality of classes includes a whole body, an upper body, and a head of a person and a target object such as a cargo, for example. As described above, in the present embodiment, the object of the processing target of the object detector 71 includes not only the whole of the object but also apart of the object. A detection region is defined by a horizontal position and a vertical position on an image and indicates a region surrounding the object of the processing target in a rectangular shape, for example (cf. FIG. 8A).

Next, the controller 50 functioning as the coordinate transformer 72 calculates coordinate transformation from the image coordinate system to the map coordinate system with respect to the position of the detected object, thereby calculates the position of the object with respect to the horizontal plane of the workplace 6 (S3). The image coordinate system is a two-dimensional coordinate system associated with an array of pixels in an image captured by the omnidirectional camera 2. In the present embodiment, the image coordinate system is an example of the first coordinate system, and the map coordinate system is an example of the second coordinate system.

In the position calculation processing (S3), as illustrated in FIGS. 5A to 5C, the controller 50 calculates, from the detected position indicating the center of the rectangular detection region, the map position of the object by using the reference height for each class of the object based on the object feature information D1, for example. The controller 50 accumulates the calculated map position in the temporary storage 51b, for example. Details of the position calculation processing (S3) will be described later.

After performing the position calculation processing (S3) in the acquired frame, the controller 50 determines whether or not the image data of the next frame is received from the omnidirectional camera 2 by the device I/F 54, for example (S4). When the next frame is received (YES in S4), the controller 50 repeats the processing in steps S1 to S3 in the next frame.

When determining that the next frame is not received (NO in S4), the controller 50 generates trajectory information based on the map information DO and the map position of the object calculated for each frame in step S3, for example (S5). The controller 50 transmits the generated trajectory information to the terminal device 4 via the network I/F 55, for example. In the example of FIG. 4, trajectory information including the trajectories F1 and F2 is generated from the respective map positions m1 and m6 of the person 11 and the target object 12 and is transmitted to the terminal device 4.

After generating the trajectory information (S5), the controller 50 terminates the processing shown in the flowchart of FIG. 6.

According to the above processing, the map position of the object is calculated based on the detection region of the object in the captured image from the omnidirectional camera 2 (S2, S3). By repeating such calculation of the map position for each frame, the trajectory information of the object moving in the workplace 6 is obtained (S5). In the present embodiment, even when detection regions differ depending on the types of objects as illustrated in FIGS. 5A to 5C, the map position based on the detected position of each detection region is calculated in the position calculation processing (S3) from the viewpoint of accurately obtaining the trajectory of each object.

The processing of generating trajectory information (S5) is not limited to be performed after the next frame is not received (NO in S4) and may be performed every time the processing in steps S1 to S3 is performed in a predetermined number of frames (e.g., one frame or several frames). In addition, in step S1 described above, image data may be acquired not only via the device I/F 54 but also via the network I/F 55. Furthermore, in step S1, the image data of one frame may be acquired by reading moving image data recorded by the omnidirectional camera 2 and stored in advance in the storage 51a, for example. In this case, instead of step S4, it is determined whether or not all frames in the moving image data are acquired, and the processing in steps S1 to S4 is repeated until all frames are acquired.

2-3. Position Calculation Processing

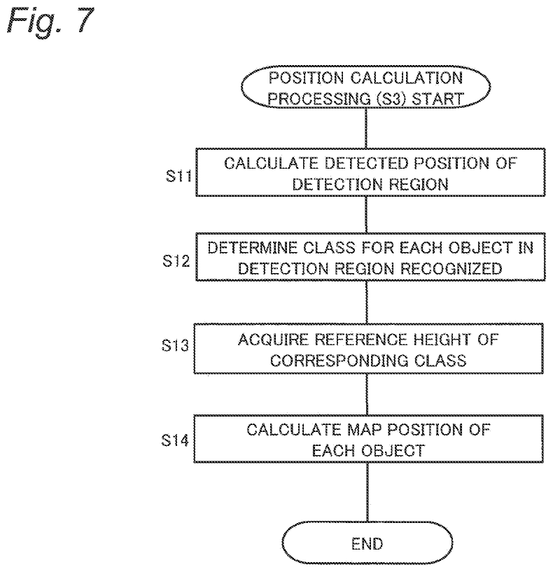

Details of the position calculation processing in step S3 of FIG. 6 will be described with reference to FIGS. 7 to 10A and 10B.

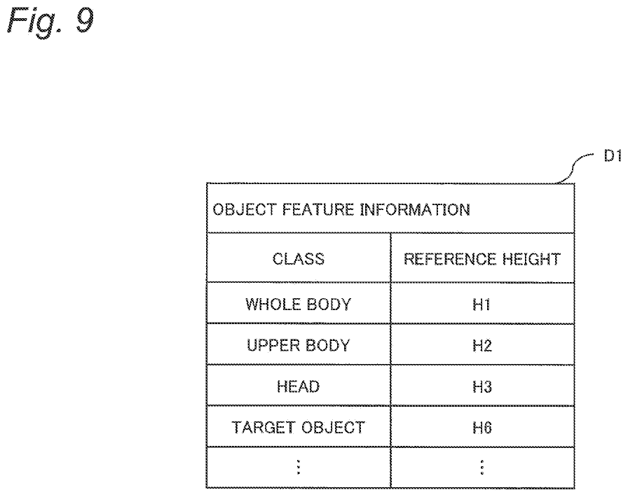

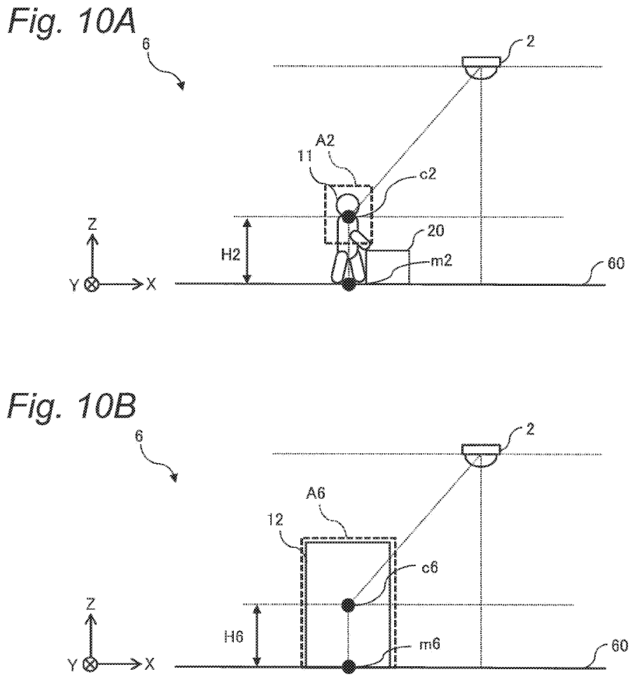

FIG. 7 is a flowchart exemplarily illustrating the position calculation processing (S3) in the trajectory extraction server 5 of the object detection system 1 according to the present embodiment. FIGS. 8A and 8B are diagrams for explaining the position calculation processing (S3). FIG. 9 is a diagram exemplarily illustrating the data structure of the object feature information D1 in the object detection system 1 according to the present embodiment. FIGS. 10A and 10B are diagrams for explaining an effect associated with the trajectory extraction server 5.

In the flowchart of FIG. 7, first, the controller 50 calculates the detected position of the detection region recognized in step S2 in FIG. 4 (S11).

FIG. 8A exemplarily illustrates a captured image Im indicated by the image data acquired in step S2 in FIG. 6. Referring to FIG. 8A, the detection region A1 of the whole body of the person 11 is recognized in the captured image Im. In the example of FIG. 8 (A), in step S11, controller 50 calculates the detected position C1 of the detection region A1 of captured image Im in the image coordinate system. The image coordinate system includes an H-coordinate indicating a position in the horizontal direction and a V coordinate indicating a position in the vertical direction of the captured image Im, for example.

Next, the controller 50 determines, referring to the detection result in the temporary storage 51b, a class for each object according to the class output by the object detector 71 in association with the detection region of the object, for example (S12). In the example of FIG. 8A, it is determined that the class of the object in the detection region A1 is the whole body of the person.

After determining the class for each object (S12), the controller 50 refers to the object feature information D1 to acquire the reference height for each determined class (S13).

The object feature information D1 exemplarily illustrated in FIG. 9 manages the “class” set in advance as processing targets of the object detector 71 and the “reference height” associated with each other. The reference height indicates the distance in the vertical direction from the horizontal plane 60 in the workplace 6 to the target position corresponding to the detected position of the detection region, for example. In the example of FIG. 8A, in step S13, the reference height “H1” corresponding to the class “whole body” is acquired based on the object feature information D1 in FIG. 9. The object feature information D1 exemplarily illustrated in FIG. 9 stores reference heights “H2”, “H3”, and “H6” respectively corresponding to the classes “upper body”, “head”, and “target object” in addition to the whole body.

Next, the controller 50 calculates the corresponding map position of each object from the detected position calculated in step S11 (S14). For example, the controller 50 performs coordinate transformation for calculating a map position from a detected position in the image coordinate system by applying a predetermined arithmetic expression using the reference height of the class acquired in step S13. For example, the predetermined arithmetic expression is a transformation expression including inverse transformation of stereographic projection.

FIG. 8B is a diagram for explaining the processing in step S14. FIG. 8B is a diagram of the workplace 6 at the time when the captured image Im of FIG. 8A is captured, as viewed from the Y direction similarly to FIG. 5A. The target position c1 in FIG. 8B indicates a position in the workplace 6 corresponding to the detected position C1 of the detection region A1 in the captured image Im in FIG. 8A. Hereinafter, an example will be described in which, in the captured image Im in FIG. 8A, the detected position C1 appears in a direction corresponding to the X direction in the workplace 6 from the image center 30 of the captured image Im.

As illustrated in FIG. 8B, when the target position c1 is at an angle θ1 from the camera center of the omnidirectional camera 2, first, a distance R1 between a vertically downward position from the omnidirectional camera 2 on the horizontal plane 60 of the workplace 6 and the map position m1 is calculated, for example. A method of calculating the distance R1 will be described below.

In a case in which coordinate transformation based on stereographic projection is applied, the following equation (1) gives a position y (e.g., in a unit of millimeter: mm) from the center of the imaging element of the omnidirectional camera 2 at which the detected position C1 appears in the imaging element, given a focal length f (mm) of the lens of the omnidirectional camera 2.

$$y = 2 f * tan ( \frac{θ1}{2} ) \qquad ( 1 )$$

Equation (2) given below also holds for the position y. Equation (2) is based on a relation in which two ratios are equal. One is a ratio between the position y and a radius L (mm) of the imaging element. The other is a ratio between a distance p1 (pixel) from an image center 30 of the captured image Im illustrated in FIG. 8A to a position where the detected position C1 appears and a diameter p0 (pixel) indicating a range that can be imaged in accordance with the radius L.

$$y = \frac{p 1 * L}{p 0} \qquad ( 2 )$$

From equations (1) and (2) given above, the angle θ1 is expressed as equation (3).

$$θ 1 = 2 arc tan ( \frac{p 1 * L}{2 f * p 0} ) \qquad ( 3 )$$

Furthermore, as illustrated in FIG. 8B, the distance R1 is expressed as equation (4) given below based on the height h of the omnidirectional camera 2 from the horizontal plane 60, the reference height H1 of the class of the whole body, and the angle θ1.

R1=(h−H1)*tan(θ1) (4)

In step S14 in FIG. 7, by arithmetic processing based on equations (3) and (4), the controller 50 calculates the distance R1 from the detected position C1 in the image coordinate system and calculates coordinates corresponding to the map position m1 in the coordinate system associated with the workplace 6 with reference to the omnidirectional camera 2, for example. The controller 50 can calculate the coordinates of the map position m1 from the coordinates by predetermined calculation including affine transformation or the like, for example.

The controller 50 holds the calculated map position m1 (cf. S14) in the temporary storage 51b and ends the position calculation processing (S3 in FIG. 6), for example. Thereafter, the controller 50 proceeds to step S4 and repeats, the above processing (S1 to S4) at a predetermined cycle for example.

According to the above processing, the map position of each object is calculated from the detected position of the detection region in the image coordinate system (cf. S11) using the reference heights H1 to H6 (cf. S13) according to the class determined for each object based on the detection result (cf. S12) (S14). Therefore, in the object detection system 1 in which a plurality of types of objects having different heights are detection targets, the map positions can be calculated accurately.

FIGS. 10A and 10B illustrate examples of calculating the map positions m2 and m6 by the reference heights according to the class of the object, as an example of the type of object, in the similar situations as those illustrated in FIGS. 5B and 5C. In the example of FIG. 10A, the map position m2 of the upper body of the person 11 is accurately calculated using the reference height H2 for the class of the upper body. In the example of FIG. 10B, the map position m6 of the target object 12 is accurately calculated using the reference height H6 for the class of the target object.

As described above, by selectively using the reference heights H1 to H6 set according to the type of object, the map positions m1 to m6 based on the respective detection regions A1 to A6 can be obtained accurately in any situations in FIGS. 5A to 5C, in which objects having different heights are detected.

2-4. Setting Processing in Terminal Device

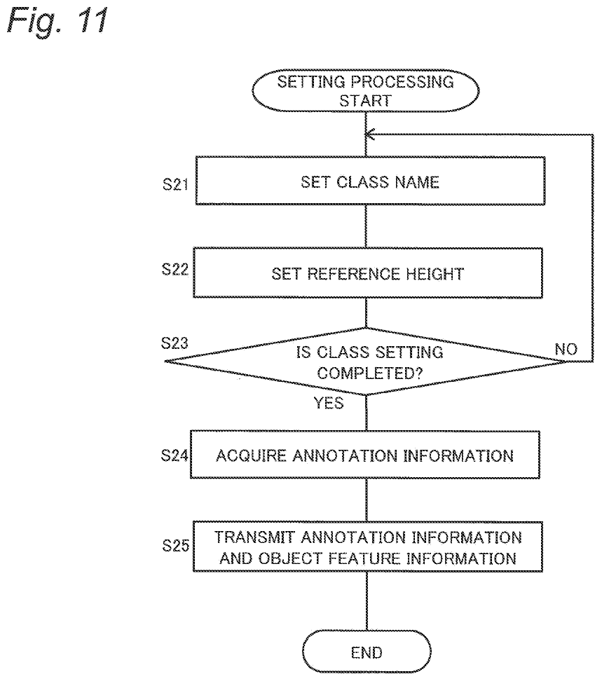

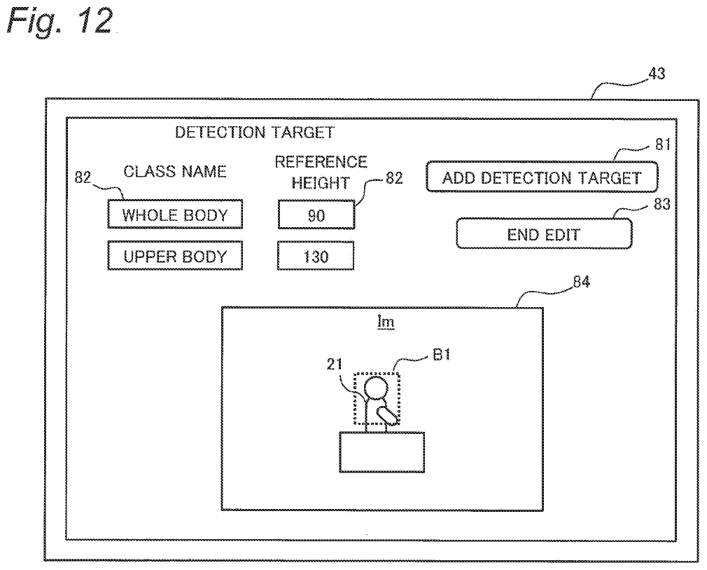

The setting processing for setting the reference height for each class as described above will be described with reference to FIGS. 11 and 12.

In the object detection system 1 according to the present embodiment, when annotation work for creating ground truth data for the object detection model 70 is performed, the reference height in the object feature information D1 can be set by the terminal device 4, for example. The grand truth data is data used as grand truth in the machine learning of the object detection model 70 and includes image data associated with a grand truth label that indicates a region on an image in which an object of each class appears, for example.

FIG. 11 is a flowchart exemplarily illustrating setting processing in the terminal device 4 according to the present embodiment. FIG. 12 is a diagram illustrating a display example of a setting screen in the terminal device 4 according to the present embodiment. Each processing illustrated in the flowchart of FIG. 11 is performed by the controller 40 of the terminal device 4, for example.

In the example of FIG. 12, the display 43 displays an add button 81, input fields 82, an end button 83, and an input area 84. The add button 81 is a button for adding a class of the processing target of the object detector 71, that is, a class of an object to be detected by the object detection model 70. The end button 83 is a button for ending setting of a class name or the like, the class name indicating the name of a class, for example.

First, by receiving a user operation inputting the class name in the input field 82, the controller 40 sets the input class name and adds a value of the class in the object feature information D1, for example (S21). The input field 82 is displayed on the display 43 in response to input of a user operation pressing the add button 81, for example. In the example of FIG. 12, the classes “whole body” and “upper body” input in the input fields 82 are added to the object feature information D1, and the class names thereof are set.

Next, the controller 40 receives a user operation inputting the reference height in the input field 82 to set the reference height of a corresponding class in the object feature information D1 (S22). In the example of FIG. 12, the reference height of the class of the whole body is set to “90”, and the reference height of the class of the upper body is set to “130”.

The controller 40 repeats the processing in steps S21 to S23 until a user operation ending the class setting, such as pressing of the end button 83, is input (NO in S23).

When the user operation to end editing the class is input (YES in S23), the controller 40 receives a user operation for performing annotation work to acquire annotation information (S24). For example, the controller 40 displays, in the input area 84, a captured image Im based on image data acquired in advance from the omnidirectional camera 2 and receives a user operation performing annotation work. The captured image Im in the input area 84 in FIG. 12 illustrates an example in which the upper body of the person 21 appears. For example, in the input area 84 in FIG. 12, a user operation drawing a region B1 surrounding the upper body of the person 21 is input in association with the class of the upper body.

For example, in step S24, by repeatedly receiving the user operation as described above for a predetermined number of captured images acquired in advance to create grand truth data, annotation information in which a class is associated with a region where an object of each class appears on a captured image is acquired.

After acquiring the annotation information (S24), the controller 40 transmits the annotation information and the object feature information D1 to the trajectory extraction server 5 via the network I/F 45, for example (S25). Thereafter, the controller 40 ends the processing shown in this flowchart.

According to the above processing, the class name and the reference height in object feature information D1 are set (S21 and S22) and are transmitted to the trajectory extraction server 5 (S25) together with the acquired annotation information (S 24). Therefore, by making it possible to set the reference height together with the class name, it is possible to easily manage the reference height for each class in association with the class of the detection target in the object feature information D1, for example.

Although the example in which the annotation information and the object feature information D1 are transmitted to the trajectory extraction server 5 in step S25 is described, the processing in step S25 is not limited thereto. For example, each piece of the information may be stored in the storage 41a in step S25. In this case, the user 3 or the like may perform an operation for reading the information from the storage 41a and input the information by an operation device or the like connectable to the device I/F 54 of the trajectory extraction server 5, for example.

Furthermore, the setting of the reference height (S22) is not limited to be performed after step S21, and may be performed after the annotation information is acquired (S24), for example. For example, a user operation editing the input reference height may be received in the input field 82 in FIG. 12.

2-5. Learning Processing of Object Detection Model

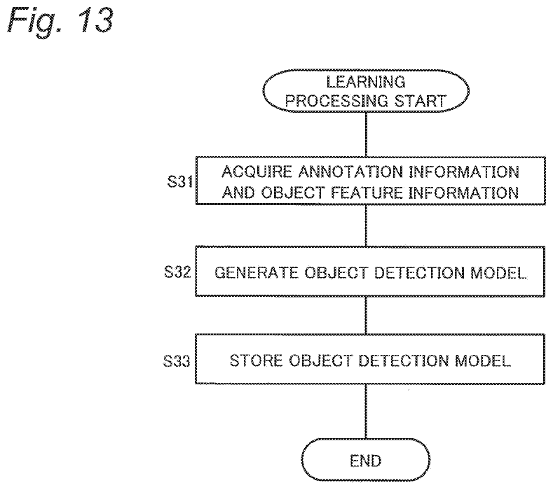

Learning processing of generating the object detection model 70 based on the annotation information acquired as described above will be described with reference to FIG. 13. In the object detection system 1 according to the present embodiment, the trajectory extraction server 5 executes learning processing of the object detection model 70, for example.

FIG. 13 is a flowchart exemplarily illustrating learning processing of the object detection model 70 in the trajectory extraction server 5 according to the present embodiment. Each processing illustrated in the flowchart of FIG. 13 is performed by the controller 50 of the trajectory extraction server 5 functioning as the model learner 73, for example.

First, the controller 50 acquires the annotation information and the object feature information D1 from the terminal device 4 via the network I/F 55, for example (S31). The network I/F 55 acquires, as the object feature information D1, the reference height for each of the plurality of classes by the user operation in the annotation work. For example, the controller 50 holds the annotation information in the temporary storage 51b and stores the object feature information D1 in the storage 51a.

For example, the controller 50 generates the object detection model 70 by supervised learning using the grand truth data based on the annotation information, for example (S32). After storing the generated object detection model 70 in the storage 51a (S33), the controller 50 ends the processing illustrated in this flowchart, for example.

According to the above processing in image data from the omnidirectional camera 2, the object detection model 70 is generated based on the annotation information associated with the class by setting processing (FIG. 11), for example. This makes it possible to obtain the object detection model 70 that can accurately recognize the detection region of the class intended by the user 3 or the like in the captured image by the omnidirectional camera 2.

The learning processing of the object detection model 70 is not limited to be performed in the trajectory extraction server 5 and may be performed by the controller 40 in the terminal device 4, for example. For example, the trajectory extraction server 5 may acquire the learned object detection model 70 from terminal device 4 via device I/F 54 or the like before starting the operation in FIG. 6. In addition, the learning processing may be performed by an information processing device external to the object detection system 1, and the learned object detection model 70 may be transmitted to the trajectory extraction server 5.

3. Effects

As described above, the trajectory extraction server 5 in the present embodiment is an example of an object detection device for detecting the position of an object on a horizontal plane of the workplace 6 (an example of an imaging plane) imaged by the omnidirectional camera 2 (an example of a camera). The trajectory extraction server 5 includes the controller 50 (an example of a processor), and the memory 51. By the device I/F 54 (an example of an acquisition interface), the controller 50 acquires image data generated by image capturing by the omnidirectional camera 2 (S1). With respect to the position of the object, the controller 50 performs coordinate transformation from coordinates indicating the detected position in the image coordinate system, as an example of first coordinates associated with an image indicated by the image data, to coordinates indicating the map positions m1 to m6 in the map coordinate system, as an example of second coordinates associated with the imaging plane (S3). The memory 51 stores the object feature information D1 as an example of setting information used for coordinate transformation. The object feature information D1 includes the reference heights H1 to H6 each as an example of a set value indicating a height from the imaging plane for each type of object among a plurality of types of objects. Based on the image data, the controller 50 acquires the detected position as an example of the position of an object in the first coordinates and the class of the object as an example of the type of object (S2). The controller 50 performs the coordinate transformation selectively using the reference heights H1 to H6 according to the type of object to calculate the map positions m1 to m6 each as an example of the position of the object in the second coordinates (S3 and S11 to S14).

According to the trajectory extraction server 5 described above, the respective map positions m1 to m6 for each object are calculated from the object detection results based on the image data in accordance with the reference heights H1 to H6 set for each of the plurality of types in the object feature information D1. Therefore, the positions of various objects can be accurately detected on the imaging plane imaged by the omnidirectional camera 2.

In the present embodiment, the classes as examples of the plurality of types include the whole body and the upper body of a person respectively as an example of a type indicating the whole of one object (an example of the first object) and as an example of a type indicating a part of the object. The object feature information D1 includes the different reference heights H1 and H2 for each of the type of whole and the type of portion. Therefore, when the detection region A2 of the part such as the upper body of the person is recognized, the map position m2 can be accurately calculated using the reference height H2 corresponding to the type of the part, for example.

In the present embodiment, the controller 50 inputs the acquired image data to the object detection model 70 to output a detection result, the detection model 70 detecting objects of the plurality of classes as an example of the plurality of types (S2). The object detection model 70 is generated by machine learning using grand truth data in which image data from the omnidirectional camera 2 is associated with a label indicating each of the plurality of classes. Therefore, the preset class can be output in association with the detection result of the object by the object detection model 70, and the type of the object can be determined based on the class in the detection result (S12).

In the present embodiment, the trajectory extraction server 5 includes the network I/F 55 as an example of an information input interface (an example of an interface to acquire information in accordance with a user operation). The network I/F 55 acquires the reference height for each of the plurality of classes in accordance with the user operation in the annotation work for creating the grand truth data for the object detection model 70 (S31).

The object feature information D1 may be set by the terminal device 4 operating as the object detection device. In this case, in the terminal device 4 including the operation interface 42 as an example of the information input interface, the operation interface 42 acquires the reference height for each of the plurality of classes according to the user operation in the annotation work (S22).

The object detection method according to the present embodiment is a method for detecting the position of an object in an imaging plane imaged by the omnidirectional camera 2. The memory 51 of the trajectory extraction server 5, which is an example of a memory of a computer, stores the object feature information D1 used for coordinate transformation from first coordinates associated with an image indicated by image data generated by image capturing by the omnidirectional camera 2 to second coordinates associated with the imaging plane, with respect to the position of an object. The object feature information D1 includes a reference height indicating a height from the imaging plane for each class of object among objects of a plurality of classes (an example of types). The method includes, by the controller 50 of the trajectory extraction server 5, acquiring image data (S1), acquiring the detected position as an example of the position of the object in the first coordinates and a class of the object based on the acquired image data (S2), and performing coordinate transformation selectively using a reference height according to the class of the object in the detection result to calculate the map positions m1 to m6 each as an example of the position of the object in the second coordinates (S3, S1 to S 14).

The present embodiment provides a program for causing a computer to execute the above object detection method. According to the object detection method and the program described above, the positions of various objects can be accurately detected on the imaging plane imaged by the omnidirectional camera 2.

The trajectory extraction server 5 in the present embodiment is an example of an object detection device for detecting a position of an object on a horizontal plane of the workplace 6 (an example of an imaging plane) imaged by the omnidirectional camera 2 (an example of a camera). The trajectory extraction server 5 includes, the controller 50, the memory 51, and the network I/F 55 as an example of an information input interface (an example of an interface). By the device I/F 54 (an example of an acquisition interface), the controller 50 acquires image data generated by image capturing by the omnidirectional camera 2 (S1). With respect to the position of the object, the controller 50 performs coordinate transformation from coordinates indicating the detected position in the image coordinate system as an example of first coordinates associated with the image indicated by image data to coordinates indicating the map positions m1 to m6 in the map coordinate system as an example of second coordinates associated with the imaging plane (S3). The memory 51 stores the object feature information D1 as an example of the setting information used for coordinate transformation. The network I/F 55 acquires information in accordance with a user operation. The object feature information D1 includes the reference heights H1 to H6 each as an example of a set value indicating a height from the imaging plane for each type of object among a plurality of types of objects. The network I/F 55 acquires the reference heights H1 to H6 for each of a plurality of classes (an example of the plurality of types) in accordance with a user operation inputting a set value (S31). Based on the acquired image data acquired, the controller 50 acquires a detection result in which the detected position as an example of the position of the object in the first coordinates and a class of the object discriminated from the plurality of types are associated with each other (S2). For each class of the object in the detection result, the controller 50 performs coordinate transformation according to the reference heights H1 to H6 acquired by the user operation and calculates the map positions m1 to m6 each as an example of the position of the object in the second coordinates (S3, S11 to S14, S31).

### Second Embodiment

The first embodiment exemplifies the trajectory extraction server 5 that calculates a map position using the reference height of the class determined according to the object detection result. The second embodiment exemplifies a trajectory extraction server 5 that calculates a map position using the reference height of a class corresponding to a predetermined priority when detection regions of a plurality of classes are recognized overlapping with each other in the object detection system 1.

Hereinafter, the description of the substantially same configuration and operation as those of the trajectory extraction server 5 according to the first embodiment will be omitted as appropriate, and the trajectory extraction server 5 according to the present embodiment will be described.

When the trajectory extraction server 5 according to the present embodiment recognizes the detection regions of a plurality of classes overlapping in a captured image, the trajectory extraction server 5 selects one class according to a predetermined priority and calculates a map position using the reference height of the class. In the present embodiment, object feature information D1 includes information indicating priority in association with each class, for example.

The predetermined priority indicates a preset order of classes with respect to classes for the detection target of the object detection model 70, such that a class with a higher priority is in an earlier order, for example. Hereinafter, a description will be given using an example in which the first priority is given to the whole body, and the second and third priorities are respectively given to the upper body and the head.

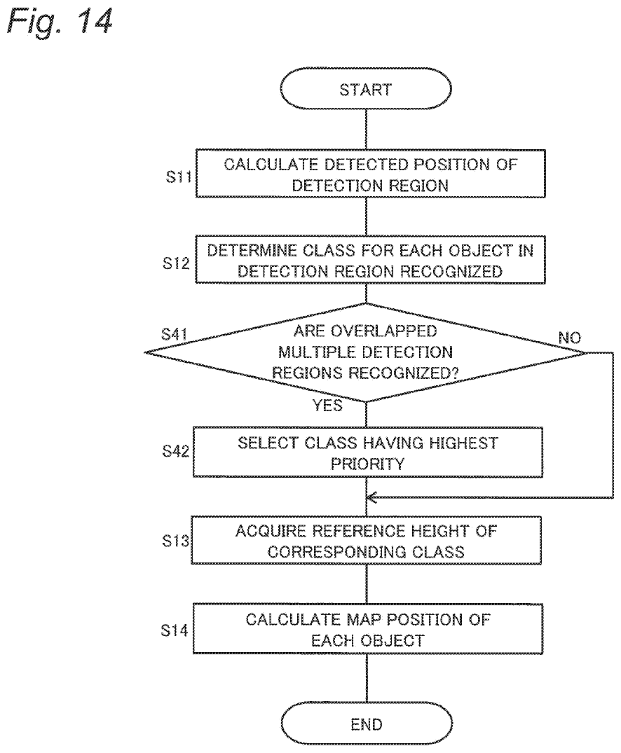

FIG. 14 is a flowchart exemplarily illustrating position calculation processing in the object detection system 1 according to the present embodiment. In the trajectory extraction server 5 according to the present embodiment, a controller 50 executes processing relating to priority (S41 and S42) in addition to processing similar to steps S11 to S12 and S13 to S14 in the position calculation processing according to the first embodiment (FIG. 7), for example.

The controller 50 determines a class for each object whose detection region is recognized in the detection result based on the image data of one frame, which acquired in step S1 in FIG. 6, (S12) and then determines whether a plurality of overlapping detection regions are recognized in the captured image indicated by the image data (S41). In step S41, the controller 50 determines whether or not detection regions of a plurality of classes are recognized at the same time and the plurality of detection regions are overlapping.

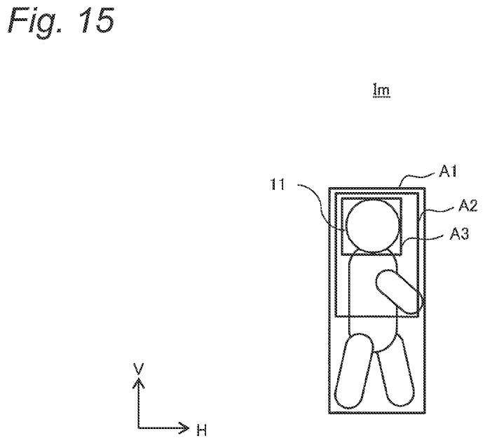

FIG. 15 is a diagram for explaining position calculation processing in the object detection system 1 according to the present embodiment. FIG. 15 illustrates an example in which detection regions A1, A2, and A3 respectively of the whole body, the upper body, and the head of the person 11 are recognized in the captured image Im. In the example of FIG. 15, the detection regions A1 to A3 are recognized as overlapping on the captured image Im.

When a plurality of overlapping detection regions are recognized (YES in S41), the controller 50 selects a class having the highest priority among the plurality of classes (S42). In the example of FIG. 15, the class of the whole body having the highest priority is selected from the classes of the whole body, the upper body, and the head.

After selecting the class having the highest priority (S42), the controller 50 acquires the reference height of the class corresponding to the selection result from object feature information D1 (S13).

When the plurality of overlapping detection regions are not recognized (NO in S41), controller 50 acquires the reference height of the class corresponding to the determination result in step S12 (S13).

According to the above processing, even when a plurality of overlapping detection regions are recognized (YES in S41), a class with higher priority is selected (S42), and the reference height of the selected class is acquired (S13). Therefore, a map position can be calculated using the reference height of the class with higher priority (S14).

As described above, in the trajectory extraction server 5 according to the present embodiment, the object feature information D1 includes information indicating priority as an example of information indicating the predetermined order set with respect to the plurality of classes. When objects of two or more classes among objects of a plurality of classes (an example of types) are detected overlapping with each other in the image indicated by the acquired image data (YES in S41), the controller 50 selects one class from the two or more classes according to the priority (S42) and calculates the map position of the object of the selected class as an example of the position of the object of the selected type in the second coordinates (S13 and S14).

Therefore, even in a case in which the overlapping detection regions of a plurality of classes are recognized, it is possible to accurately calculate a map position based on the detection region of an object with higher priority with respect to the objects of the plurality of classes. A predetermined condition may be set in the determination of whether the plurality of overlapping detection regions are recognized (S41). For example, when 90% or more of one of the plurality of detection regions is included in the other region, it may be determined that the plurality of detection regions are recognized overlapping with each other (YES in S41).

### Third Embodiment

The second embodiment exemplifies the trajectory extraction server 5 that calculates a map position according to a preset priority when a plurality of overlapping detection regions are recognized. The third embodiment exemplifies a trajectory extraction server 5 that calculates a map position based on a relation with a trajectory of an object corresponding to a detection region when a plurality of overlapping detection regions are recognized in an object detection system 1.

Hereinafter, the description of the substantially same configuration and operation as those of the trajectory extraction server 5 according to the first and second embodiment will be omitted as appropriate, and the trajectory extraction server 5 according to the third embodiment will be described.

When the trajectory extraction server 5 according to the present embodiment recognizes the detection regions of a plurality of classes overlapping with each other on a captured image, the trajectory extraction server 5 selects a class for which the detection region corresponds to a map position that is likely to be connected as a trajectory in comparison with a detection result based on the image data of an immediately preceding frame.

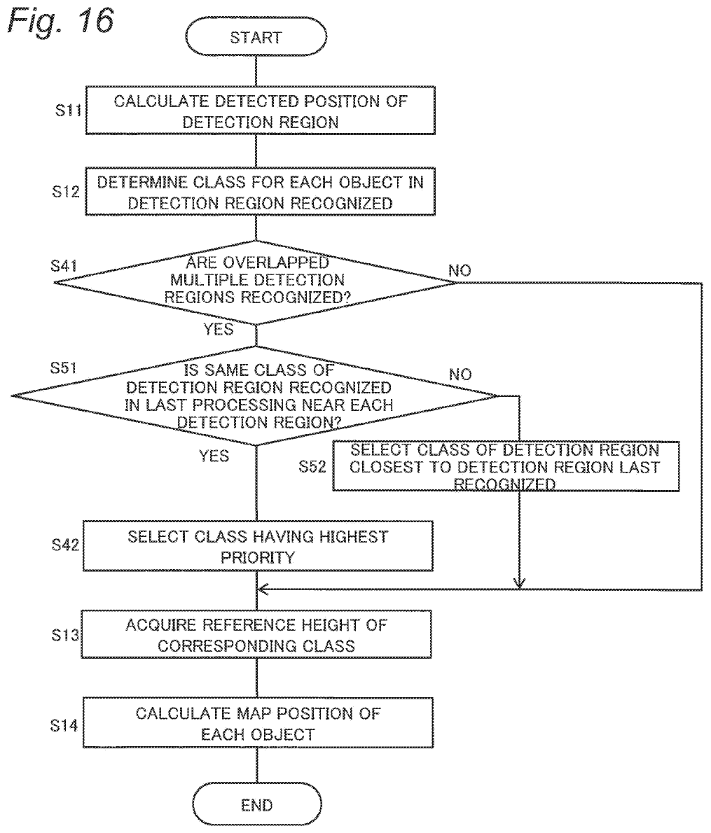

FIG. 16 is a flowchart exemplarily illustrating position calculation processing in the object detection system 1 according to the present embodiment. In the trajectory extraction server 5 according to the present embodiment, the controller 50 executes processing related to comparison with an immediately preceding detection result (S51 and S52) in addition to processing similar to steps S11 to S14 and S41 to S42 in the position calculation processing according to the second embodiment (FIG. 14), for example.

When determining that a plurality of overlapping detection regions are recognized (YES in S41), the controller 50 determines whether the detection result of the previous image recognition processing (S2 in FIG. 4) includes a detection region of the same class as each current detection region exists in its vicinity on the captured image (S51). The controller 50 determines, referring to the previous detection result held in the temporary storage 51b in step S51, whether or not the previous detection result includes a detection region where the distance between the detected positions of the detection regions of the same class of the previous time and the current time is smaller than a predetermined distance, for example. The predetermined distance is set in advance as a distance that is small enough to be regarded as being close on the image. For example, the predetermined distance is set according to the size of the detection region such that magnitudes of the H component and the V component are about ¼ to ⅓ of the width and the height of the rectangular detection region, respectively.

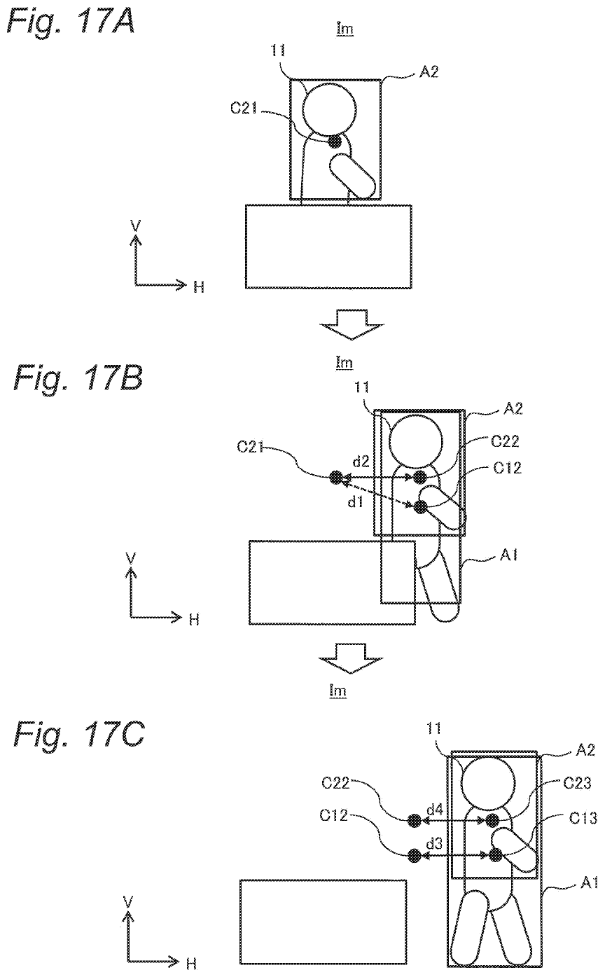

FIGS. 17A and 17B are diagrams for explaining position calculation processing in the object detection system 1 according to the present embodiment. FIGS. 17A to 17C exemplarily illustrate captured images Im indicated by the image data of three consecutive frames acquired from an omnidirectional camera 2. Referring to FIG. 17A, a part of the body of a person 11 is hidden by the equipment, and a detection region A2 of the upper body is recognized. Referring to FIG. 17B, the person 11 moved from the time of FIG. 17A, and a detection region A1 of the whole body and the detection region A2 of the upper body are recognized. Referring to FIG. 17C, the person 11 further moved from the time of FIG. 17B, and the detection region A1 of the whole body and the detection region A2 of the upper body are recognized.

For example, in the captured image Im in FIG. 17B, it is determined in step S51 whether or not the detection regions of the same class are recognized in the previous captured image Im in FIG. 17A near the current detection regions A1 and A2. In the examples of FIGS. 17A and 17B, since a detection region of the whole body class is not included in the detection result of the object by the previous image recognition processing, it is determined as “NO” in step S51.

When the detection result of the previous image recognition processing does not include the detection region of the same class as this time near each current detection region (NO in S51), the controller 50 selects the class of the detection region of the current detection regions which is nearest to the previous detection region (S52). In the example of FIG. 17B, distances d1 and d2 between a detected position C21 of the previous detection region A2 and detected positions C12 and C22 of the current detection regions A1 and A2 are compared. Since the distance d2 is smaller than the distance d1, the class of the upper body is selected as the detection region A2 being closest to the previous detection region A2 among the current detection regions A1 and A2.

On the other hand, when the previous detection result includes the detection regions of the same class near each detection region (YES in S51), the controller 50 selects the class having the highest priority according to the predetermined priority similar to that of the trajectory extraction server 5 according to the second embodiment (S42).

FIGS. 17B and 17C illustrate examples in which a distance d3 between the previous detected position C12 and a current detected position C13 is smaller than the predetermined distance with respect to the detection region A1 of the whole body, and a distance d4 between the previous and current detected positions C22 and C23 is smaller than the predetermined distance with respect to the detection region A2 of the upper body. In the example of FIG. 17C, it is determined as “YES” step S51, and the class of the whole body having the highest preset priority is selected in step S42, for example.

According to the above processing, when a plurality of overlapping detection regions are recognized (YES in S41), the class of the detection region recognized closest to the last detection region on the captured image is selected comparing with the previous detection result based on the image data of the previous frame (S51 to S52). By acquiring the reference height of the selected class (S13), it is possible to calculate a map position (S14) using the reference height of the class detected closest to the previous detection result, that is, the class for which the corresponding map position is likely to be connected to the map position based on the previous detection result as a trajectory.

In step S51 in FIG. 16, it may be determined for each current detection region whether the previous detection result includes a detection region near on the captured image regardless of the same or different classes. In this case, when the previous detection region is recognized near each current detection region (YES in S51), the class of the current detection region closest to the previous detection region may be selected (S52). On the other hand, when the previous detection region is not recognized near each current detection region (NO in S51), the class having the highest priority may be selected from the current detection result (S42).

Furthermore, in step S13 in FIG. 16, a class may be selected based on information different from priority. For example, it is possible to use information in which the placement or the like of various equipment 20 based on the map information of the workplace 6 is associated with the image coordinate system. For example, based on the information, the class of the upper body or the whole body may be selected according to whether or not the detected position of the detection region is recognized within a predetermined range regarded as being near the equipment 20 in the workplace 6 on the captured image.

As described above, in the trajectory extraction server 5 according to the present embodiment, the controller 50 generates trajectory information based on the image data sequentially acquired, the trajectory information including a map position as an example of the position of the object in the second coordinates for each piece of the image data (S1 to S5). When objects of two or more types among the plurality of classes (an example of the plurality of types) are detected overlapping with each other in an image indicated by newly acquired image data (YES in S41), the controller 50 selects one class from the two or more classes of objects based on a position included in the trajectory information (S51 and S52) and calculates the map position of the object of the selected class as an example of a position of the object of the selected type in the second coordinates (S13 and S14). Therefore, even when a plurality of overlapping detection regions are recognized, a map position can be calculated using the reference height of the class of the detection region that can be regarded as being easily connected as a trajectory based on the position included in the trajectory information.

### Other Embodiments

As described above, the first to third embodiments are described as examples of the technique disclosed in the present application. However, the technique in the present disclosure is not limited to this and can be applied to embodiments in which changes, substitutions, additions, omissions, and the like are made as appropriate. It is also possible to combine the respective constituent elements described in each of the above embodiments into a new embodiment. Therefore, other embodiments will be exemplified below.

The second embodiment exemplifies the priority in a case in which the detection target of the object detection model 70 is the whole body and upper body of the person and the target such as the cargo. However, another priority may be used. For example, when the object detection system 1 is applied to the measurement of a risk level upon detection of the approach between a person and a vehicle, the detection target of the object detection model 70 includes the person and the vehicle. In this case, priority may be set in the order of a vehicle and a person. As a result, for example, when the detection region of a vehicle and the detection region of a person who drives the vehicle are recognized overlapping with each other on an image, map positions are calculated using the reference height of the class of the vehicle. In this way, the position based on a detection result can be accurately calculated according to the priority according to the application of the object detection system 1.

The third embodiment exemplifies the case in which when a plurality of overlapping detection regions are recognized in steps S51 and S52 in FIG. 16, one class of the plurality of classes is selected from the relationship between the current detection region and the detection result based on the image data of the immediately preceding frame. In the present embodiment, in steps S51 and S52, a class that can be regarded as being easily connected to a trajectory may be selected by comparing the current detection result with the detection results based on the image data of the immediately preceding and subsequent frames. For example, in the present embodiment, the image data of a plurality of consecutive frames are acquired in step S1 in FIG. 6.

Each of the above embodiments exemplifies the example in which one omnidirectional camera 2 is included in the object detection system 1, but the number of omnidirectional cameras 2 is not limited to one and may be plural. For example, in the object detection system 1 including the plurality of omnidirectional cameras 2, the trajectory extraction server 5 may perform the operation in FIG. 6 for each omnidirectional camera and then perform processing for integrating information based on the plurality of omnidirectional cameras 2.

Each of the above embodiments exemplifies the case in which the map position is calculated as the position according to the horizontal plane 60 of the workplace 6 based on the detection result in the position calculation processing of step S3 in FIG. 6, but a coordinate system different from the map coordinate system may be used. For example, the position based on the detection result may be calculated by a coordinate system indicating the position on the horizontal plane 60 corresponding to the omnidirectional camera 2 before being converted into the map coordinate system. In this case, the calculated position may be converted into the map coordinate system in, for example, step S5 in FIG. 6. In addition, in the example of the object detection system 1 including the plurality of omnidirectional cameras 2, in step S3, the position of the detection result based on each omnidirectional camera may be calculated by performing coordinate transformation according to, for example, each omnidirectional camera.

Each of the above embodiments exemplifies the case in which the map position corresponding to the detected position is calculated using the detected position of the rectangular detection region as the position of the detection region. In the present embodiment, the position of a detection region is not limited to the detected position, and for example, a midpoint of one side of the detection region may be used. Further, the position of a detection region may be the positions of a plurality of points or may be the center of gravity of a region other than a rectangle.

Each of the above embodiments exemplifies the case in which the reference height is set together with the annotation work by the setting processing (FIG. 11) in the terminal device 4, but the setting of a reference height is not limited thereto. For example, in the trajectory extraction server 5, after the object detection model 70 is generated and before the basic operation (FIG. 6) is started, a reference height may be set together with the work of setting various parameters associated with coordinate transformation from the image coordinate system to the map coordinate system. The trajectory extraction server 5 according to the present embodiment sets a reference height according to a user operation of inputting a reference height for each class from, for example, the terminal device 4 or an external operation device via the device I/F 54.

Each of the above embodiments exemplifies the case in which the detection target of the object detection model 70 includes the class corresponding to the portion of the object such as the upper body of the person, but only the class of the whole of the object such as the whole body of a person may be included. For example, the trajectory extraction server 5 according to the present embodiment may include, in addition to the object detection model 70, a detection model designed for the upper body as a detection target and a detection model designed for the head as a detection target and may apply the respective detection models of the upper body and the head to the detection region of the whole body by the object detection model 70. By determining the type of object such as the whole body, the upper body, or the head instead of the class determination in step S12 based on the detection result of each detection model, it is possible to calculate a map position using the reference height according to the type of object.

As a result, even when annotation work is not performed in advance on the body parts such as the upper body and the head in the captured image of the workplace 6, it is possible to discriminate each part based on the captured image of the workplace 6 and accurately calculate a position by the processing in step S3.

The above case exemplifies the trajectory extraction server 5 using each of the detection models of the upper body and the head, which are targets for map position calculation. However, instead of each of the detection models, a plurality of part detection models may be used which are designed for the respective parts of the body such as the head, the hand, and the foot as detection targets. For example, the types of objects such as the whole body, the upper body, and the head appearing in a captured image may be determined by applying each part detection model to the detection region of the whole body by the object detection model 70 and combining the respective detection results.

In the trajectory extraction server 5 according to the above embodiment, the controller 50 recognizes the region of the whole body of the person as an example of a region where the whole of one object (an example of the first object) is detected in the image indicated by the acquired image data. The controller 50 recognizes the regions of the upper body and the head each as an example of one or more regions where one or more parts of the one object are detected in the recognized region of the whole. The controller 50 discriminates the class as an example of the type of the object based on a recognition result regarding the regions of the one or more parts.

Furthermore, in a case in which a person is a target of object detection in the object detection system 1, each part of the body of the person may be determined as the type of object by applying a technology of skeleton detection or posture estimation to the captured image instead of the plurality of detection models including the object detection model 70 described above.

Each of the above embodiments exemplifies the case in which the object detector 71 outputs the detection region in association with the class as the detection result. In the present embodiment, the detection region defined by the position and size on the image may be output as the detection result regardless of the class. For example, in step S12, the type of object may be determined based on the position and size of the detection region instead of the class.

Each of the above embodiments exemplifies the trajectory extraction server 5 as an example of an object detection device. In the present embodiment, for example, the terminal device 4 may be configured as an object detection device, and the controller 40 may execute various operations of the object detection device.

Each of the above embodiments exemplifies the omnidirectional camera 2 as an example of a camera in the object detection system 1. In the present embodiment, the object detection system 1 may include various cameras in addition to the omnidirectional camera 2. For example, the camera of the system 1 may be various imaging apparatuses that adopt various projection methods such as an orthogonal projection method, an equidistant projection method, and an equal solid angle projection method.

Each of the above embodiments exemplifies the application of the object detection system 1 to the workplace 6. In the present embodiment, a site to which the object detection system 1 and the trajectory extraction server 5 are applied is not particularly limited to the workplace 6, and may be various sites such as a distribution warehouse or a sales floor of a store.

As described above, the embodiments have been described as examples of the technique disclosed in the present disclosure. For this purpose, the accompanying drawings and detailed description are provided.

Therefore, components in the accompanying drawings and the detailed description may include not only components essential for solving problems, but also components that are provided to illustrate the above technique and are not essential for solving the problems. Accordingly, such inessential components should not be readily construed as being essential based on the fact that such inessential components are shown in the accompanying drawings or mentioned in the detailed description.

Furthermore, since the embodiments described above are intended to illustrate the technique in the present disclosure, various changes, substitutions, additions, omissions, and the like can be made within the scope of the claims and the scope of equivalents thereof.

### INDUSTRIAL APPLICABILITY

The present disclosure is applicable to various object detection devices that detect the positions of a plurality of types of objects using a camera and is applicable to, for example, a trajectory detection device, a monitoring device, and a tracking device.

What is claimed is:

1. An object detection device for detecting a position of an object on an imaging plane imaged by a camera, the object detection device comprising:
a processor to acquire image data generated by image capturing by the camera and perform coordinate transformation, with respect to a position of the object, from first coordinates associated with an image indicated by the image data to second coordinates associated with the imaging plane; and
a memory to store setting information used for the coordinate transformation, wherein
the setting information includes a set value indicating a height from the imaging plane for each type of object among a plurality of types of objects, and
the processor
acquires a position of the object in the first coordinates and a type of the object based on the image data and
calculates a position of the object in the second coordinates by performing the coordinate transformation using the set value corresponding to the type of the object.

2. The object detection device according to claim 1, wherein
the plurality of types include a type indicating a whole of a first object and a type indicating a part of the first object, and
the setting information includes different set values for each type of the type of whole and the type of part.

3. The object detection device according to claim 1, wherein
the processor inputs the acquired image data to an object detection model to output a detection result, the object detection model detecting objects of the plurality of types, and
the object detection model is generated by machine learning using grand truth data in which image data from the camera is associated with a label indicating each of the plurality of types.

4. The object detection device according to claim 3, further comprising
an interface to acquire information in accordance with a user operation, wherein
the interface acquires the set value for each of the plurality of types in accordance with a user operation in annotation work for creating the grand truth data.

5. The object detection device according to claim 1, wherein
the setting information includes information indicating priority set for the plurality of types, and
when objects of two or more types among the plurality of types are detected overlapping with each other in an image indicated by the acquired image data, the processor selects one type from the two or more types according to the priority, and calculates a position of an object of the selected type in the second coordinates.

6. The object detection device according to claim 1, wherein
the processor generates trajectory information based on image data sequentially acquired, the trajectory information including the position of the object in the second coordinates for each piece of the image data in sequence,
when objects of two or more types among the plurality of types are detected overlapping with each other in an image indicated by newly acquired image data, the processor
selects one type from the two or more types of objects based on a position included in the trajectory information, and
calculates a position of an object of the selected type in the second coordinates.

7. The object detection device according to claim 2, wherein the processor
recognizes a region where the whole of the first object is detected in an image indicated by the acquired image data,
recognizes one or more regions where one or more parts of the first object are detected in the recognized region of the whole, and
discriminate the type of the object based on a recognition result regarding the regions of the one or more parts.

8. The object detection device according to claim 2, wherein
the image data includes a first image indicating a first frame and a second image indicating a second frame captured after the first frame, and
when objects of two or more types are detected overlapping with each other in the second image and the two or more types include a type of an object detected in the first image, the processor calculates the position of the object in the second coordinates according to the type of the object detected in the first image.

9. The object detection device according to claim 8, wherein when the two or more types do not include the type of the object detected in the first image, the processor calculates the position of the object in the second coordinates according to a type of an object detected nearest to the object detected in the first image among the two or more types.

10. An object detection method for detecting a position of an object on an imaging plane imaged by a camera, wherein
a memory of a computer stores setting information used for coordinate transformation, with respect to a position of the object, from first coordinates associated with an image indicated by image data generated by image capturing by the camera to second coordinates associated with the imaging plane,
the setting information includes a set value indicating a height from the imaging plane for each type of object among a plurality of types of objects, and
the object detection method comprising, by a processor of the computer:
acquiring the image data;
acquiring a position of the object in the first coordinates and a type of the object based on the image data; and
calculating a position of the object in the second coordinates by performing the coordinate transformation using the set value corresponding to the type of the object.

11. A program for causing a computer to execute the object detection method according to claim 10.

12. An object detection device for detecting a position of an object on an imaging plane imaged by a camera, the object detection device comprising:
a processor to acquire image data generated by image capturing by the camera and perform coordinate transformation, with respect to a position of the object, from first coordinates associated with an image indicated by the image data to second coordinates associated with the imaging plane;
a memory to store setting information used for the coordinate transformation; and
an interface to acquire information in accordance with a user operation, wherein
the setting information includes a set value indicating a height from the imaging plane for each type of object among a plurality of types of objects,
the interface acquires a set value for each of the plurality of types in accordance with a user operation inputting the set value, and
the processor
acquires a detection result in which a position of the object in the first coordinates is associated with a type of the object discriminated from the plurality of types based on the acquired image data,
performs, for each type of the object in the detection result, the coordinate transformation in accordance with the set value acquired by the user operation to calculate a position of the object in the second coordinates.
